(19) United States
(12) Patent Application Publication
(10) Pub. No.: US 2004/0162732 A1
(43) Pub. Date: Aug. 19, 2004

(54) System and method for credit card replenishment of a wireless subscriber's account balance

(76) Inventors: Rubens Rahim, Markham (CA); Christopher McRaild, Mississauga (CA)

Correspondence Address: REDKNEE INC., 2560 MATHESON BLVD. EAST, SUITE 500, MISSISSAUGA, ON, L4W4W9, CA

(21) Appl. No.: 10/366,506

(22) Filed: Feb. 14, 2003

(51) Int. Cl. G06F 17/60; H04B 7/216

(52) U.S. Cl. 705/1

(57) ABSTRACT

The system and method for credit card replenishment of a wireless subscriber's account balance detailed herewith enables wireless subscribers to recharge their account balances in self-configured and/or telecommunications carrier-configured amounts via Unstructured Supplementary Services Data (USSD) by charging the subscriber's credit card or similar type of disbursement instrument. Once a subscriber has stored such credit information and/or other banking details on the SCP by registering relevant details with the telecommunications carrier, the system and method disclosed herein prompts the subscriber for an amount and their PIN security code. The system and method then charges a subscriber's credit card, and adds the desired recharge amount to the subscriber's prepaid account balance. If no credit card or PIN information is stored for the subscriber, or if the Credit Card Information System (CCIS) rejects the charge, an appropriate error message is returned.

### CROSS-REFERENCE TO RELATED APPLICATIONS

Patent application Ser. No. 10/307,335 entitled “Improved method for implementing an Open Charging (OC) middleware platform and gateway system”.

### STATEMENT REGARDING FEDERALLY SPONSORED RESEARCH OR

### DEVELOPMENT

Not Applicable

### REFERENCE TO A MICROFICHE APPENDIX

Not Applicable

### BACKGROUND ART

In the state of the art, it is well known and documented that mobile phones and/or other wireless devices no longer merely serve to facilitate non land-line voice telecommunications and may function as web browsers, text chat rooms, to name a few. To this end, much art is devoted to facilitating e-commerce, now m-commerce (mobile commerce), and the selection, approval and/or authorization of commercial transactions at one's mobile handset and/or wireless device.

Consider, European Patent Application No. 1136961 by Calvo Pesquera et al., entitled System and process for remote payments and transactions in real time by mobile telephone. Basically, the patent is broadly worded in order to address the following sequence of events:

(i) the payer uses a digital phone to request a service or item (the payee may be identified by a variety of methods);

(ii) the payer's MSISDN is used as an index key to retrieve a ‘secret’ PIN;

(iii) the system challenges the payer using SMS/USSD in order to acquire the PIN;

(iv) assuming that the challenge is successful, a confirmation message is sent to the Payer; and

(v) The appropriate amount is debited from the payer's prepaid or postpaid account.

We submit that, aside from being based on prior art which is readily and publicly available within the state of the art (as for instance, the information provided by the MET initiative (http://www.mobiletransaction.org/documents.html), with academic references dating back to at least calendar year 1997); that the art claimed focuses on the subscriber's MSISDN as being the key index, ad does not, in any sense, accommodate for a pseudonym which would be correlated to a subscribers account (which could very well be indexed by something other than the MSISDN). Additionally, its focus on the IMEI as being some short of key verification parameter. The patent describes several mechanisms of IMEI retrieval which would simply not work based on ‘state of the art’ network implementations. Aside and in consideration of which, the IMEI remains a meaningless attribute for the purpose at hand, and would likely cause additional inherent complexity given that SIM swapping is a common practice.

In further addressing the prior art identified herewith, our invention of present does not does not store or otherwise require the storage of a pre-established safety criterion which is correlated to a given MSISDN; nor does it require secondary information relating to the type of digital mobile equipment being used by a given subscriber.

Additionally, as per the claims three (3) through six (6) set out by Calvo Pesquera et al.'s patent application, the verification messages referred to therein remain unrequired by our invention of present.

Further, the advances represented by our invention of present, remain unaffected by other bodies of prior art. As with U.S. patent application No. 20020152179 by Racov entitled Remote payment method and system, wherein a mobile communications device is employed by a customer to instruct a given remote payment system to provide funds to a merchant, where the funds are transferred from a customer account to a merchant account. Nonetheless, the invention of present speaks specifically to advances as they pertain to replenishing a wireless subscriber's prepaid account balance using their wireless device in question.

And as also with U.S. Pat. No. 6,487,401 to Suryanarayana, et al., and U.S. patent application No. 20020077076 also by Suryanarayana et al., both entitled Prepaid wireless telephone account regeneration in a wireless access protocol system, which detail a method for recharging a prepaid telephone airtime account in a wireless access protocol system comprising a mobile client, a service control point, a wireless telephony application server, and a wireless access protocol (WAP) gateway. The art of which remains specific to WAP gateways unlike that of present, which is interface agnostic (though in the preferred embodiment a USSD Gateway is employed).

Additionally, the art taught by the former patent (and patent application) remains for the most part “network initiated” utilizing the WAP gateway's netalert functionality; the art demonstrated by our application remains user-initiated over (in the preferred embodiment) a USSD gateway. Further it fails to specifically delineate the method for retrieving funds from the subscriber's credit card account or other account to recharge their prepaid account. As it, indeed, does not explicitly explain how the SCP retrieves funds from the subscriber's credit card account. There is no explicit description of how the application interfaces to a credit card information service (CCIS) to provide credit card details and obtain funds to replenish the account.

In alternate embodiments of the art of present seeking the protection of Letters Patent, the user's PIN and/or credit card extension as a security mechanism to authenticate them as such and charge their credit card account (or similar). There remains no explicit explanation of this feature in the patent and/or patent application of Suryanarayana, et al.'s.

References Cited:

| | | | |
|---|---|---|---|
| U.S. Patent Application | October 2002 | Racov | 705/67 |
| 20020152179 | | | |
| U.S. Patent Application | June 2002 | Suryanarayana, | 455/406 |
| 20020077076 | | et al. | |
| U.S. Pat. No. 6,487,401 | November 2002 | Suryanarayana, | 455/406 |
| | | et al. | |
| Foreign Patent | September 2001 | | EP. |
| Document(s) | | | |
| 1136961 | | | |

Other References

Mobile electronic Transactions. 4^{th} Feb. 2003. Mobile electronic Transactions Ltd. [http://www.mobiletransaction.org/documents.html]

### TECHNICAL FIELD

The present invention relates generally to telecommunication network implementations; and in particular to an improved method and system for recharging and/or replenishing wireless subscriber accounts by credit card (or similar monetary/credit instruments).

### SUMMARY OF THE INVENTION

The System and Method for Credit Card Replenishment of a Wireless Subscriber's Account Balance disclosed herein enables wireless subscribers to recharge their prepaid account balances with a credit card (or similar type of numismatic implementation) directly from their wireless and/or mobile device. Indeed, the simplicity, convenience and predilection which the System and Method for Credit Card Replenishment of a Wireless Subscriber's Account Balance affords wireless subscribers remains apparent, over and above the trite alternative of dialing a telecommunications carrier's (or related) voice menu to request a recharge of such. Wireless subscribers select an amount (either predetermined or configurable) using the user interface provided by most generic Unstructured Supplementary Services Data (USSD) Gateways, and the system and method disclosed herein interacts with a telecommunication carrier's (or related) Credit Card Information System (CCIS) to charge a credit card or similar type of credit instrument or numismatic implementation).

The invention of present, in the preferred instance, utilizes the functionality of and makes a request to the Open Charging (OC) middleware platform and gateway system as detailed in patent application Ser. No. 10/307,335 to credit the recharge amount, plus any bonus amount (if any), to the subscriber in question's account. Technicians skilled in the art will recognize that the invention of present need not be limited to the aforementioned Open Charging (OC) middleware platform and gateway system and other similar network implementations may be employed without diluting the intent and scope as such.

### BRIEF DESCRIPTION OF THE DRAWINGS

FIG. 1A illustrates a typical, non-limiting embodiment of the system level architecture employed in the disclosure of present;

FIG. 1B details a non-limiting call-flow of the system and method for replenishment of a wireless subscriber's account balance using a credit card (or similar means).

### DETAILED DESCRIPTION OF THE PREFERRED EMBODIMENTS

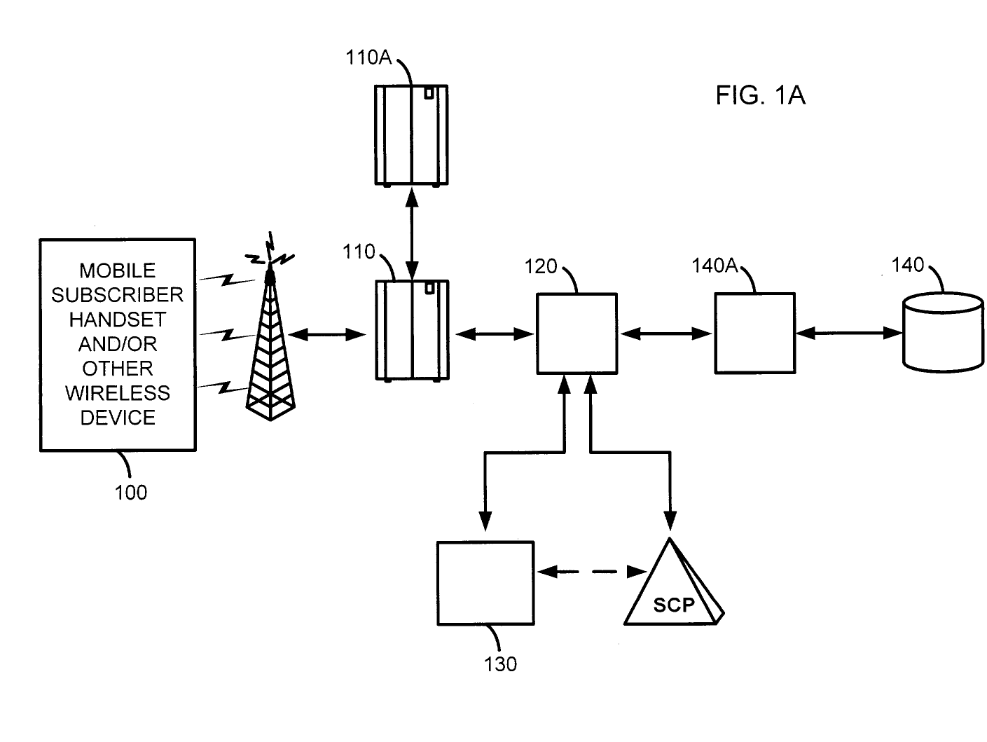

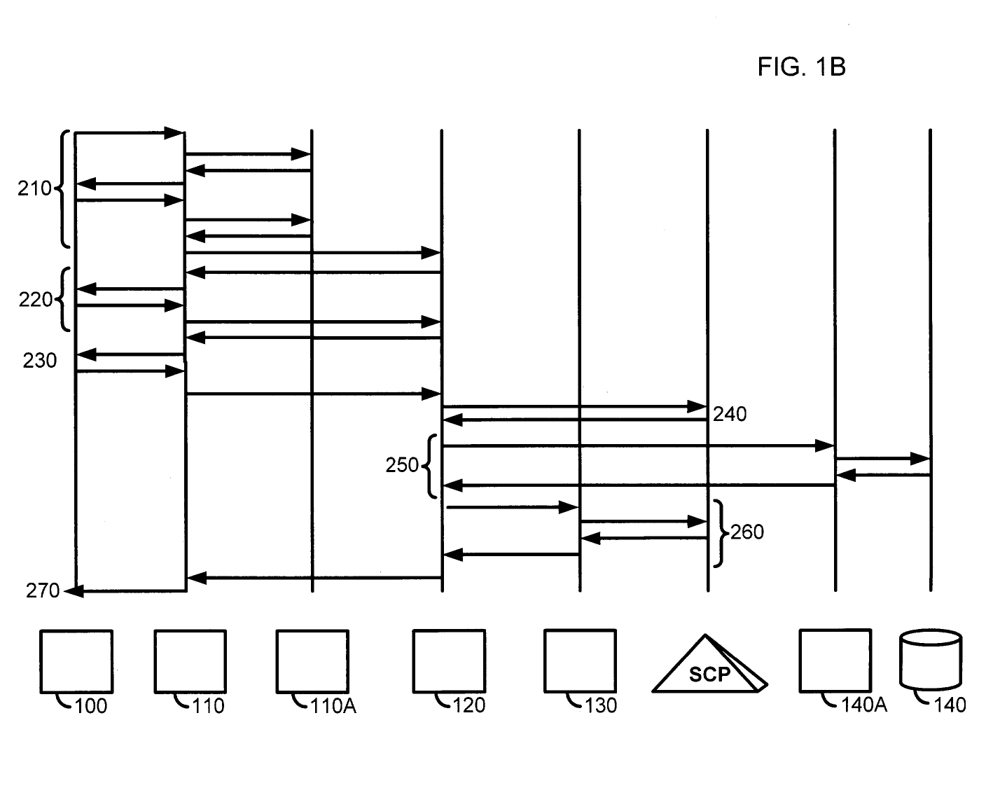

FIGS. 1A and 1B are intended to both represent—at difference levels of details and technical nuance—the totality of the art seeking the protection of Letters Patent. And indeed are to be read, interpreted and understood as being conjunctive.

Now, with reference to FIG. 1A, the generic, high-level, system architecture encompassed by the invention of present is therewith presented. The system and method 120 disclosed herein interfaces with the Open Charging (OC) middleware platform and gateway system 130 (as detailed in patent application Ser. No. 10/307,335), an Unstructured Supplementary Services Data (USSD) Gateway 110 (and USSD Portal 110A), a telecommunication carrier's (or third party's) Credit Card Information System (CCIS) 140 (via a Credit Card Authentication Interface 140A), and SCP. Technicians skilled in the art will recognize that the invention of present need not be limited to the aforementioned Open Charging (OC) middleware platform and gateway system and other similar network implementations may be employed without diluting the intent and scope as such. Indeed, further to which, practitioners and other honourable members skilled in the art will recognize that a variety of gateways, portals (et al.) apart from USSD may be utilized without diluting the intent and scope of the invention of present, and its inclusion herewith serves merely for the purpose of elucidation, simplicity and ease of instruction.

FIG. 1B is a call flow diagram which depicts the typical ‘calls’ made between components on a telecommunications carrier's network, where a wireless subscriber 100 invokes the system and method disclosed herein (at 120), via an Unstructured Supplementary Services Data (USSD) Portal 110A and USSD Gateway 110, and successfully completes a credit card transaction. Said subscriber 100 invokes the service by selecting the system and method disclosed 120, from a menu presented by the USSD Portal 110A, therewith generating a string code which the USSD Gateway 110 recognizes as belonging to the application module 120. (This call serves as the entry point into the system and method for credit card replenishment application 120). Practitioners and other honourable members skilled in the art will recognize that a variety of gateways (et al.) apart from USSD may be utilized without diluting the intent and scope of the invention of present, and its inclusion herewith serves merely for the purpose of elucidation, simplicity and ease of instruction.

Still with reference to FIG. 1B, at 210 the subscriber 100 attempts to invoke the USSD Portal 11A, by entering the appropriate USSD string (for example *123#). The HLR (not shown) forwards the message to the USSD Gateway 110. The USSD Gateway 110 invokes the USSD Portal application, which sends menu information to the subscriber 100 allowing said user to select from a list of available USSD applications (in vary embodiments). Upon selection, the USSD Gateway 110 invokes the system and method disclosed herein 120.

At 220, the system and method 120 is launched and requests the user for a recharge amount, presented as a menu of available recharge amounts configured by the telecommunications carrier in question. The user 100 makes a selection and the USSD Gateway 110 sends the amount value back to the system and method at 120. At 230, the system and method 120 displays the selected amount and asks the subscriber 100 to confirm the purchase by entering such said subscriber's pre-registered PIN (or similar verification numbers, actions, et al.).

Still with reference to FIG. 1B., at 240, the system and method disclosed 120 queries the subscriber's 100 PIN details from the SCP. In alternate embodiment, where the entered PIN does not match the stored PIN from the telecommunication carrier-in-question's SCP, the system and method 120 prompts the user 100 to re-enter the PIN. Now, upon verification of the user's 100 PIN, the system and method 120 queries the subscriber-in-question's credit card details from the SCP.

Now at 250, once said PIN (or other such security/authentication means) has been verified 140A, the system and method 120 credits the subscriber's account for the amount charged, and adds any applicable bonus amounts (in accordance with the application configuration). In the preferred embodiment, credits are performed via an Open Charging (OC) middleware platform and gateway system 130 as detailed in patent application Ser. No. 10/307,335. Technicians skilled in the art will recognize that the invention of present need not be limited to the aforementioned Open Charging (OC) middleware platform and gateway system and other similar network implementations may be employed without diluting the intent and scope as such.

From which, at 260, the art disclosed forwards the subscriber's 100 credit card details to the credit card information service (CCIS) 140 to thereby charge the user's credit card account. The CCIS 140 returns an appropriate response code. Should the subscriber's credit card details be declined, then the system and method disclosed herein rolls back the transaction to the Open Charging (OC) middleware platform and gateway system 130 and deducts the amount from the subscriber's prepaid account balance. Again, technicians skilled in the art will recognize that the invention of present need not be limited to the aforementioned Open Charging (OC) middleware platform and gateway system and other similar network implementations may be employed without diluting the intent and scope as such. Additionally, practitioners skilled in the art will appreciate that the invention of present need not necessarily be limited to credit cards and indeed, may reasonably be said to import and/or employ similar types of monetary/credit instruments.

In concluding the sequence of events 270, the system and method 120 sends a terminating USSD message 110 back to the user, along with an appropriate success or error message. Success messages include the subscriber's 100 new balance. Practitioners and other honourable members skilled in the art will recognize that a variety of messaging systems may be employed apart from USSD without diluting the intent and scope of the invention of present, and its inclusion herewith serves merely for the purpose of elucidation, simplicity and ease of instruction.

The system and method for credit card replenishment of a wireless subscriber's account balance 120 additionally utilizes a security model which ensures that subscriber's credit card details are stored on the requisite hardware and/or application server no more than is necessary and even then, only for the duration of the application call, and are discarded immediately afterwards. Credit card details are temporarily retrieved from and permanently stored on the telecommunication carrier's SCP.

What is claimed is:

1. A system and method for credit card replenishment of a wireless subscriber's account balance, which may be invoked at any time, even after such balance has expired.

2. The system of claim 1, where the system may either be user-initiated or network-initiated (as through USSD, WAP, IVR and so on).

3. The system of claim 2, where the wireless subscriber invokes the system via a gateway and portal system (as through USSD for instance).

4. The system of claim 3, which may be invoked from a menu screen on the wireless and/or mobile device in question.

5. The system of claim 4, which generates a string code (or similar logical instructions) with which the gateway recognizes as belonging to the application module of the credit card replenishment system.

6. The system of claim 5, whereby the credit card replenishment system exists as part of a computer program product, comprising:
a) a computer readable memory medium; and
b) a computer program including the logic required to the steps, methods and rules as such.

7. The system of claim 6, which presents the wireless user with a menu of available recharge and/or replenishment amounts.

8. The system of claim 7, which may be configured by the telecommunications carrier in question and/or the wireless user themselves.

9. The system of claim 7, where the wireless user makes a selection as such.

10. The system of claim 9, where such selection is returned credit card replenishment system via the appropriate gateway and/or portal.

11. The system of claim 10, where said wireless user is asked to confirm such selection through any number of verification methods.

12. The system of claim 11, where such verification methods may include a pre-registered PIN or their CV2 code (the three (3) or four (4) digit security code on the back of most credit cards).

13. The system of claim 11, where the credit card replenishment system queries the wireless user's credit card details from the relevant SCP.

14. The system of claim 13, where the credit card replenishment system credits the wireless user's account for the amount charged.

15. The system of claim 14, which may include any applicable bonus amounts (as per the telecommunication carrier's configuration and requirements).

16. The system of claim 14, where the credit card replenishment system forwards said credit card details to the credit card information service to thereby charge the wireless user's credit card account.

17. The system of claim 16, where the credit card information service returns an appropriate response code, logic or other set of instructions.

18. The system of claim 17, wherein the response indicates that the wireless user's credit card details have been declined.

19. The system of claim 18, where the credit card replenishment system rolls back the transaction to an Open Charging (OC) middleware platform and gateway system or similar type of method, system and/or apparatus used to deduct the amount instead from the user's prepaid account balance.

20. The system of claim 17, where the credit card replenishment system sends a terminating message to the handset and/or other device of the wireless user, including an appropriate success of error message.

21. The system of claim 2, where the credit card recharge remains network-initiated.

22. The system of claim 21, whereby the SCP or other such repository of subscriber profiles and account information remains the initiating element within the network.

23. The system of claim 21, whereby the credit card replenishment system exists as part of a computer program product, comprising:
a) a computer readable memory medium; and
b) a computer program including the logic required to the steps, methods and rules as such.

24. The system of claim 23, which presents the wireless user with a menu of available recharge and/or replenishment amounts.

25. The system of claim 24, which may be configured by the telecommunications carrier in question and/or the wireless user themselves.

26. The system of claim 24, where the wireless user makes a selection as such.

27. The system of claim 26, where such selection is returned credit card replenishment system via the appropriate gateway and/or portal.

28. The system of claim 27, where said wireless user is asked to confirm such selection through any number of verification methods.

29. The system of claim 28, where such verification methods may include a pre-registered PIN or their CV2 code (the three (3) or four (4) digit security code on the back of most credit cards).

30. The system of claim 28, where the credit card replenishment system queries the wireless user's credit card details from the relevant SCP.

31. The system of claim 30, where the credit card replenishment system credits the wireless user's account for the amount charged.

32. The system of claim 31, which may include any applicable bonus amounts (as per the telecommunication carrier's configuration and requirements).

33. The system of claim 31, where the credit card replenishment system forwards said credit card details to the credit card information service to thereby charge the wireless user's credit card account.

34. The system of claim 33, where the credit card information service returns an appropriate response code, logic or other set of instructions.

35. The system of claim 34, wherein the response indicates that the wireless user's credit card details have been declined.

36. The system of claim 35, where the credit card replenishment system rolls back the transaction to an Open Charging (OC) middleware platform and gateway system or similar type of method, system and/or apparatus used to deduct the amount instead from the user's prepaid account balance.

37. The system of claim 34, where the credit card replenishment system sends a terminating message to the handset and/or other device of the wireless user, including an appropriate success of error message.

38. An improved security model which ensures that said subscriber's credit card details are stored on the credit card replenishment system's application server only for the duration of the application call (credit card details are temporarily retrieved from and permanently stored on the carrier's SCP).

39. The system of claim 38, where such credit card and/or other financial details are discarded immediately thereafter.
